(19) United States
(12) Patent Application Publication
(10) Pub. No.: US 2025/0124302 A1
(43) Pub. Date: Apr. 17, 2025

(54) METHODS FOR AUTOMATED STRATIGRAPHY INTERPRETATION FROM WELL LOGS AND CONE PENETRATION TESTS DATA

(71) Applicant: SCHLUMBERGER TECHNOLOGY CORPORATION, Sugar Land, TX (US)

(72) Inventors: Marie ETCHEBES, Clamart (FR); Zikri BAYRAKTAR, Cambridge, MA (US); Marie Emeline Cecile LeFranc, Lysaker (NO)

(21) Appl. No.: 18/691,725

(22) PCT Filed: Sep. 20, 2022
(86) PCT No.: PCT/US2022/044083

§ 371 Date: Mar. 13, 2024

Related U.S. Application Data
(60) Provisional application No. 63/246,090, filed on Sep. 20, 2021.

(51) Int. Cl. G06N 3/096; G01V 5/12; G01V 20/00

(52) U.S. Cl. CPC G06N 3/096; G01V 5/12; G01V 20/00

(57) ABSTRACT

A method that allows for fast and accurate interpretation of well log or geotechnical data or cone penetration test data to provide a labelled discrete log of stratigraphy and/or grain size trends. The discrete log can be used for advanced subsurface interpretation and modeling and identifying correlations between wells and 3D static model conditioning.

### CROSS-REFERENCE TO RELATED APPLICATIONS

The present application claims priority to U.S. Provisional Patent Application 63/246,090 filed Sep. 20, 2021, the entirety of which is included by reference.

### FIELD OF THE DISCLOSURE

The present disclosure generally relates to a method, using machine learning algorithms, to automatically interpret sequence stratigraphy/grain size trends from well logs data and geotechnical data. A poor description of local cross sections or logs would result in a poor stratigraphy and environment understanding, poor correlations, and finally poor 3D models of the subsurface.

### BACKGROUND INFORMATION

Several industries, such as, oil and gas, renewable energy industry (windmills), civil engineering, mining, geotechnical engineering, and the like, can benefit from the methods, using machine learning algorithms, to automatically interpret sequence stratigraphy/grain size trends from well logs data and geotechnical data disclosed herein.

The character of log response that penetrates a stratum often reflect changes of grain size. This character may be important to engineers for several types of applications used in various fields.

One way of obtaining logs of the subsurface is gamma ray (“GR”) logging. Abrupt changes in the GR log response are interpreted to be related to sharp lithological breaks associated with unconformities and sequence boundaries (Krassay, 1998). The principle GR log shapes were frequently used for interpreting the depositional setting of sedimentary cycles. The GR log can depict some common trends, which is known to one skilled in the art with the aid of this disclosure. For example, see, Emery 1996 and Kendal and Pomar, 2005, which are incorporated herein in their entirety.

Another log that can be used to understand subsurface stratigraphy is Spontaneous Potential (“SP”) logs. SP logs measure the electrical current that occurs naturally in boreholes as a result of salinity differences between the formation water and the borehole mud filtrate. SP logs can provide information on permeability and help with identifying bed boundaries.

The logs have common dip and log patterns for both nonmarine/continental environments and continental shelf environments, as depicted in Gilreath, 1987, which is incorporated herein in its entirety.

As described in Robertson 2010, Lunne et al., 1997, and Schiltz, 2020, which are incorporated herein in their entirety, there is a close analogy between vertical trend and the signature of two cone penetration tests (“CPT”) derived parameters. The derived parameters include normalized soil behavior index (Ic) and hydraulic conductivity (KSBTn) and gamma ray measurements.

There is a need to provide for interpretation of data from well logs of various types.

There is a further need to provide this interpretation of data in an economical manner.

There is a further need to provide for automated analysis and interpretation of data from wellbore logs.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method for automated stratigraphy interpretation is disclosed. The method comprises creating at least two training datasets to be used for the interpretation and developing at least one machine learning technique, wherein the at least one learning technique is configured to extract and automatically label stratigraphic trends. The method may further comprise computation of uncertainties for the interpretation.

In another example embodiment, a computer program product is disclosed. The product may comprise a computer usable medium having a computer readable program code embodied therein, said computer readable program code adapted to be executed to implement a method for generating a report, and configured to run on a computer, said method comprising creating at least two training datasets to be used for the interpretation, developing at least one machine learning technique, wherein the at least one learning technique is configured to extract and automatically label stratigraphic trends and computation of uncertainties for the interpretation.

### BRIEF DESCRIPTION OF THE FIGURES

Certain embodiments, features, aspects, and advantages of the disclosure will hereafter be described with reference to the accompanying drawings, wherein like reference numerals denote like elements. It should be understood that the accompanying figures illustrate the various implementations described herein and are not meant to limit the scope of various technologies described herein.

FIG. 1 shows an example interactive web application to display and correct training dataset issues;

FIG. 2 depicts an example of Transfer Learning (TL) workflow where the model is trained on multiple different datasets, in which only the prediction head of the model (colored layer) is replaced in each of the training step, and rest of the model weights (gray layers) are transferred from previous training. Most suitable architecture was a UNet architecture for such TL hence the name of “Transfer Learning UNet” is coined in this work;

FIG. 3 depicts an example conventional UNet architecture for 1D input signal like GR. It also allows additional 1D signals to be added into input as additional channels if other tool signals are collected at the same time;

FIG. 4 depicts an example modified UNet can also behave like an Autoencoder, where model takes in 1D GR signal (or multi-tool signals in different channels) and duplicates it at the output;

FIG. 5 depicts an example of sliding window principle;

FIG. 6 depicts an example of results of analysis using gamma ray as input Results of the analysis using gamma ray as input. Track 1: gamma ray, track 2: manual interpretation (yellow for channel and green for floodplain), tracks 3 and 4: ML results: Grain size trends and uncertainty.

FIG. 7 depicts stratigraphy of HKW area (https://offshorewind.rvo.nl/soilzh);

FIG. 8 depicts results of the analysis using CPT data (i.e. Normalized soil behavior index (Ic)) as input. Track 1: Ic log; Track 2: Robertson discrete log; Track 3: Grain size trends (ML results for a window average of 2) and Track 4: Grain size trends (ML results for a window average of 12); and

FIG. 9 depicts ML results validation against seismic.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements. Commonly, these terms relate to a reference point at the surface from which drilling operations are initiated as being the top point and the total depth being the lowest point, wherein the well (e.g., wellbore, borehole) is vertical, horizontal or slanted relative to the surface.

The disclosed methods include creating training datasets, development of specific machine learning techniques to extract and automatically label the stratigraphic trends, e.g., grain size trends, and computation of uncertainties.

The training data can start with known datasets, for example, data from Xeek challenge (https://xeek.ai/challenges/gamma-log-facies/data). This challenge was proposed to identify which body of water created rock radioactivity measurements, using supervised learning. The proposed training dataset includes synthetic gamma ray logs from 6000 synthetic wells. Each well has 1100 rows and a random number of log facies. Along with GR, the user is given a label for five common log facies: 0—serrated, 1—symmetrical, 2—cylindrical, 3—funnel, and 4—bell. One skilled in the art with the aid of this disclosure would know the five common log facies with the aid of this disclosure, examples of the main curve shapes utilized by the disclosed methods can be found in Emery, 1996 and Kendall and Pomar, 2005, which are incorporated herein by reference.

The original data set, whether derived from Xeek challenge or otherwise obtained from acquired data, publicly available information, or otherwise, can be further improved. Training dataset improvement can be accomplished by using multiple training datasets by applying transfer learning (TL). TL can be loosely defined as training a machine learning model with a certain dataset and then retraining the same model with one or more other datasets, where learning from prior datasets is carried over to secondary trainings. What model learns is the weights (in case of neural networks) or other model parameters during training with a specific dataset and through TL, such weights and parameters are transferred to the training with next set of data. Depending on the workflow, both supervised and unsupervised training methods can be applied in TL as carried out in this work. Another dimension of TL is that it allows utilization of both synthetic data and field measurements data with minimal modifications to the trained model that we utilized. Synthetic datasets can be generated through known mathematical functions with acceptable levels of noise added, or sophisticated numerical geological modeling software can create highly realistic datasets for the purpose of training machine learning models in either supervised or unsupervised learning schema. Measurements from the field are also utilized in the workflow as they do not come with proper labels, hence they are usually more suitable for unsupervised learning methods.

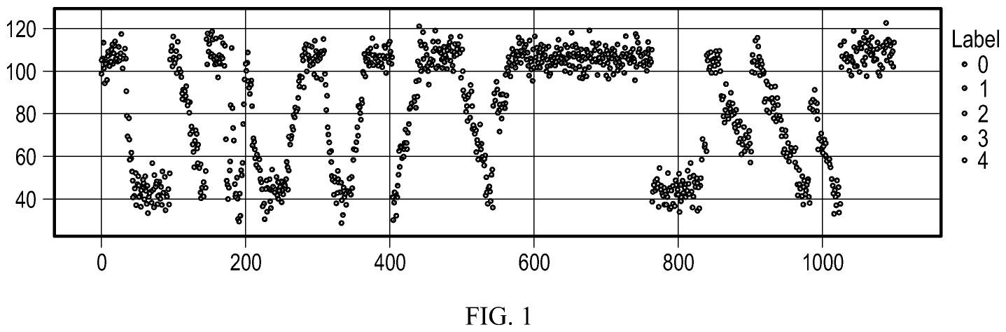

One of the challenges with using multiple datasets is that they might have different ranges, deviations, trends as well as conflicting labels. To alleviate issues with labels, we devised an interactive web application, where domain experts can load the data along with their corresponding labels to make changes to any data point. FIG. 1 is an illustration of a GR signal colored by the different labels, where user can interactively select the data from the web application and change the label. Label correction is a critical step which reduces issues with the data and helps the model correctly learn the patterns in the signal.

FIG. 1 depicts an interactive application to display and correct training dataset issues. The machine learning can include the use of UNet architecture, transfer learning, and uncertainty quantification from sliding window approach.

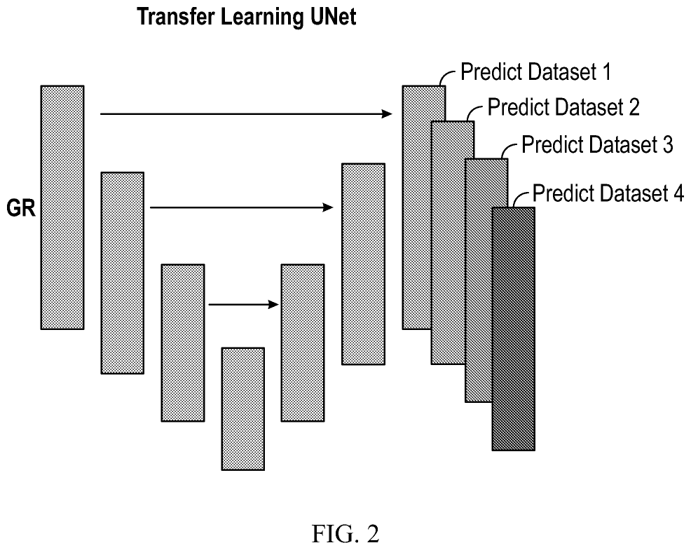

In the disclosed methods, multiple labeled and unlabeled datasets can be utilized through Transfer Learning approach to UNet architecture. In a multi-step training schema, last layer of UNet can be replaced with a prediction layer suitable for the supervised-or unsupervised learning task while rest of the weights can be kept from previous training. At each stage with new data, all the layers and new prediction layer can be retrained. This allows us to teach the model both labeled synthetic data as well as the unlabeled field-data sequentially by only replacing the final prediction layer. As shown in the FIG. 2, for each dataset (#1 to #4), prediction layer of the model is replaced in each of the training step. Final training must be made with the labeled dataset to achieve a model that can carry out the desired classification task that is desired at inference. Referring to FIG. 2, transfer learning workflow is illustrated where the model is trained on multiple different datasets, in which only the prediction head of the model (colored layer) is replaced in each of the training step, and rest of the model weights (gray layers) are transferred from previous training. Most suitable architecture was a UNet architecture for such TL hence the name of “Transfer Learning UNet” is coined in this work.

Input size to the model architecture is preset and cannot be changed after training. However, the length of a well log could be any size, usually significantly larger than the input. A sliding window approach can be implemented with a stepping size smaller than the input size. Because the output is the same length of the input, i.e., model predicts a class label for every single input point, sliding window generates multiple predictions per input data point. An uncertainty calculation can be carried out from the multiple predictions and reported to the user.

The following part shows applications of the present invention in two different domains: [1] O&G using Gamma Ray log, and [2] civil engineering (e.g., Windfarm stability), using geotechnical data such as CPT (Cone Penetration Testing). For both applications, the number of inputs and parameters to provide is limited to the following:
1. Input data: A continuous log
2. Step Size: User can define a step size of their choice at inference for the sliding window method which affects the number of overlapping windows. Increments of 10 or more are recommended to allow multiple overlapping predictions for each input point and for computation of uncertainty.
3. Label Smoothing: A simple window averaging method can be applied to post-prediction labels to smooth out any spurious predictions and outliers. Value for the window size of this label smoothing method can also be defined by the user. 4. Window Average: A simple window averaging method can be applied to the input data to smooth out outliers and high frequency input signal. Window size for smoothing input can be defined by the user which can affect the model predictions. The outputs are two logs—classes as a discrete log (from 0 to 4) and their associated uncertainty as a continuous log (from 0 to 1).

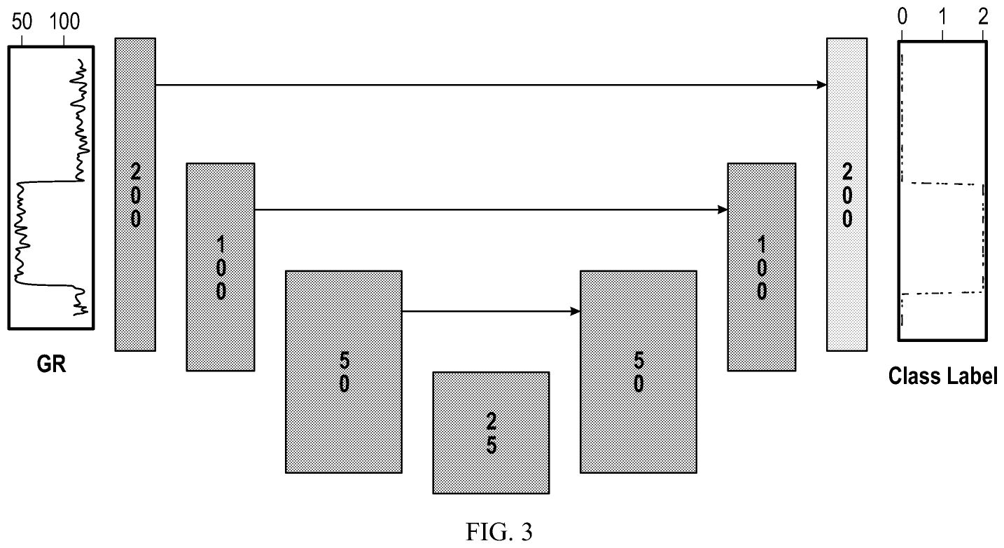

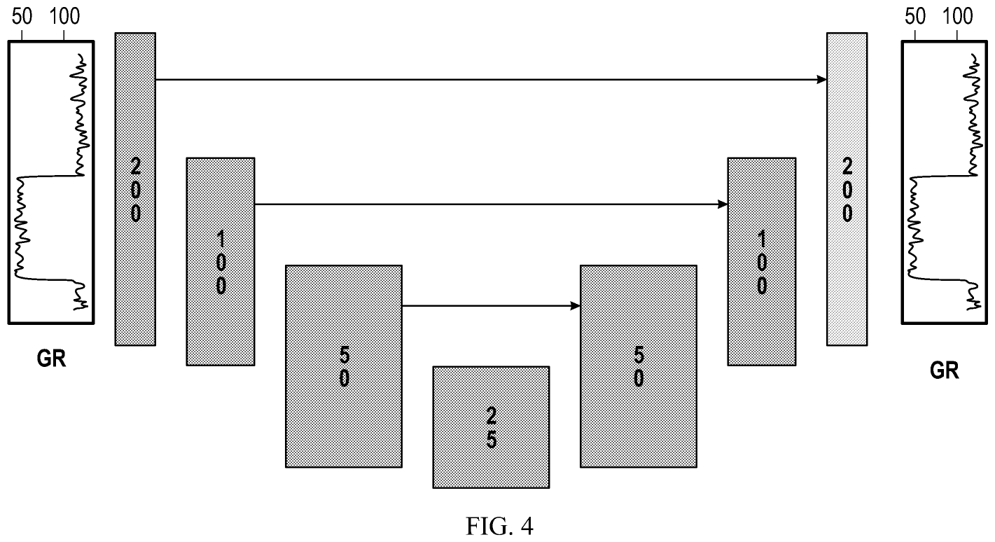

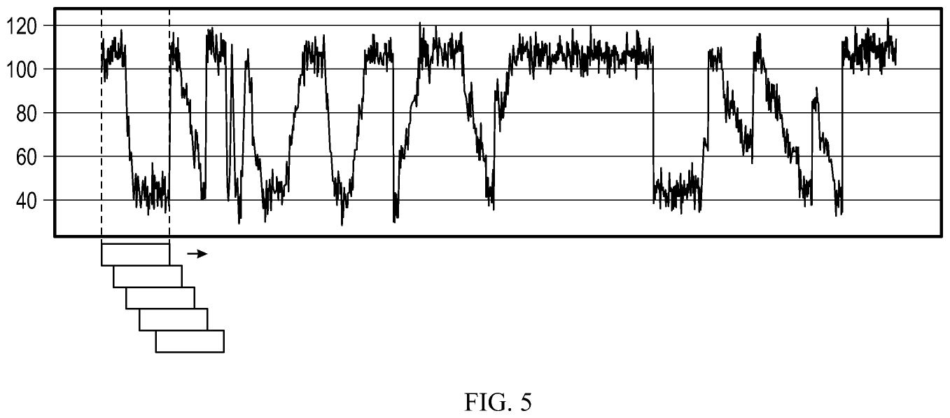

Referring to FIG. 3, A conventional UNet architecture for 1D input signal like GR. It also allows additional 1D signals to be added into input as additional channels if other tool signals are collected at the same time. Referring to FIG. 4, a Modified UNet can also behave like an Autoencoder, where model takes in 1D GR signal (or multi-tool signals in different channels) and duplicates it at the output, as the signal passes through multiple convolutional layers as demonstrated above. Referring to FIG. 5, a sliding window illustration is presented.

### O&G Application

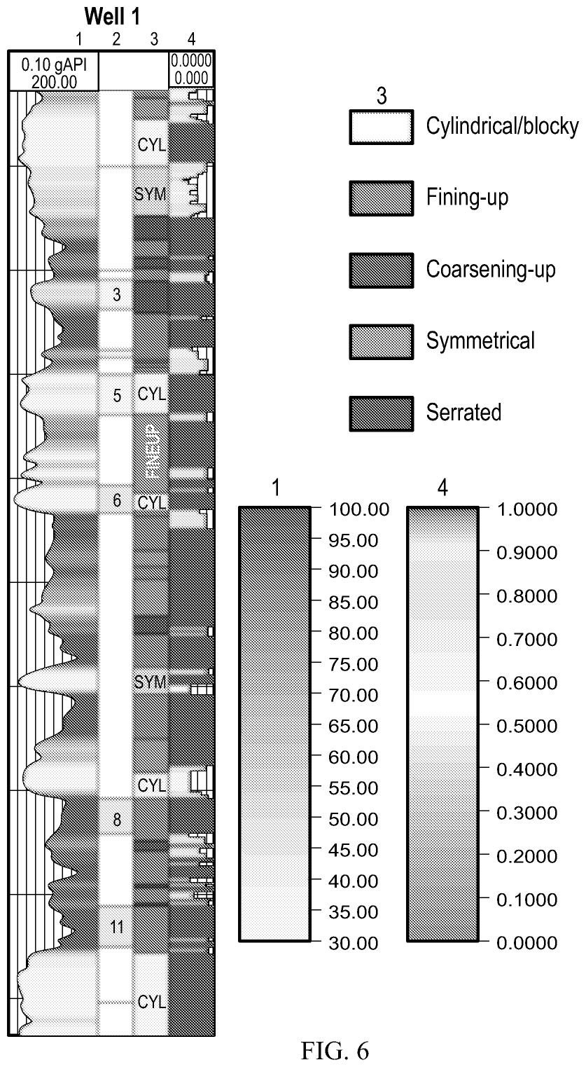

For this example, as depicted In FIG. 6, a gamma ray log is used as input. The depositional environment is fluvial: Cylindrical class (yellow) has a high probability to represent a channel, Fining-up class (red) probably represents a point bar, Coarsening-up class (blue) possibly represents a crevasse splay, and Serrated (brown) characterizes floodplain.

With reference to FIG. 6, a manual interpretation of the gamma ray for Well 1 showed the channels in yellow and the shaly barriers in green on track 2. We can see a very good correlation between the manual interpretation and the ML results on track 3. It shows that the present invention can be used as a fast, accurate, and unbiased method to interpret stratigraphy from well log data, and particularly GR in this example.

### Civil/Geotechnical Application (Windfarm Stability Analysis)

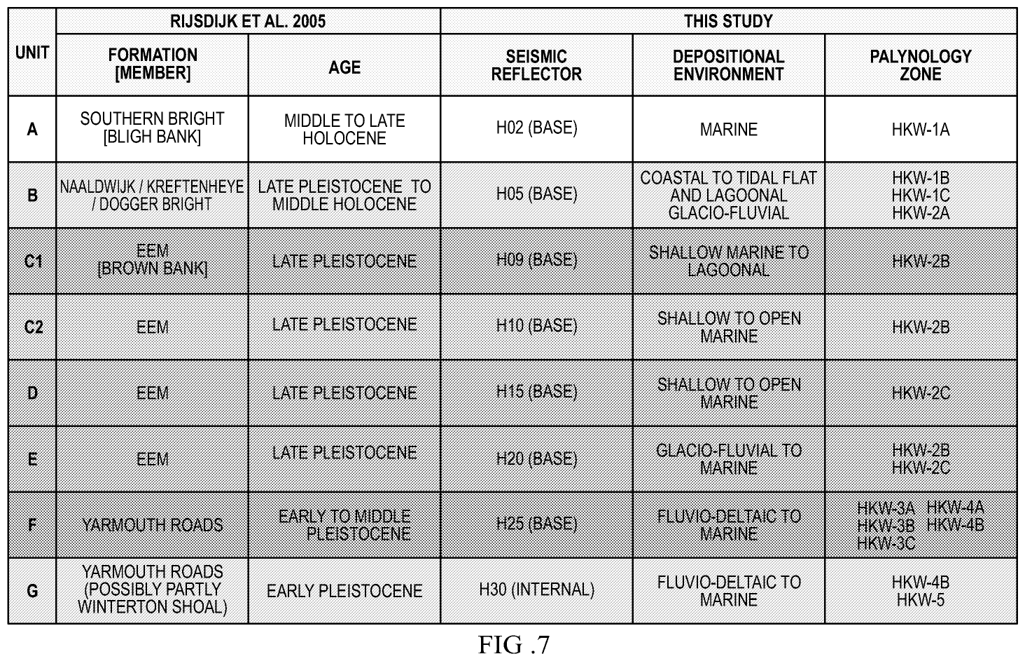

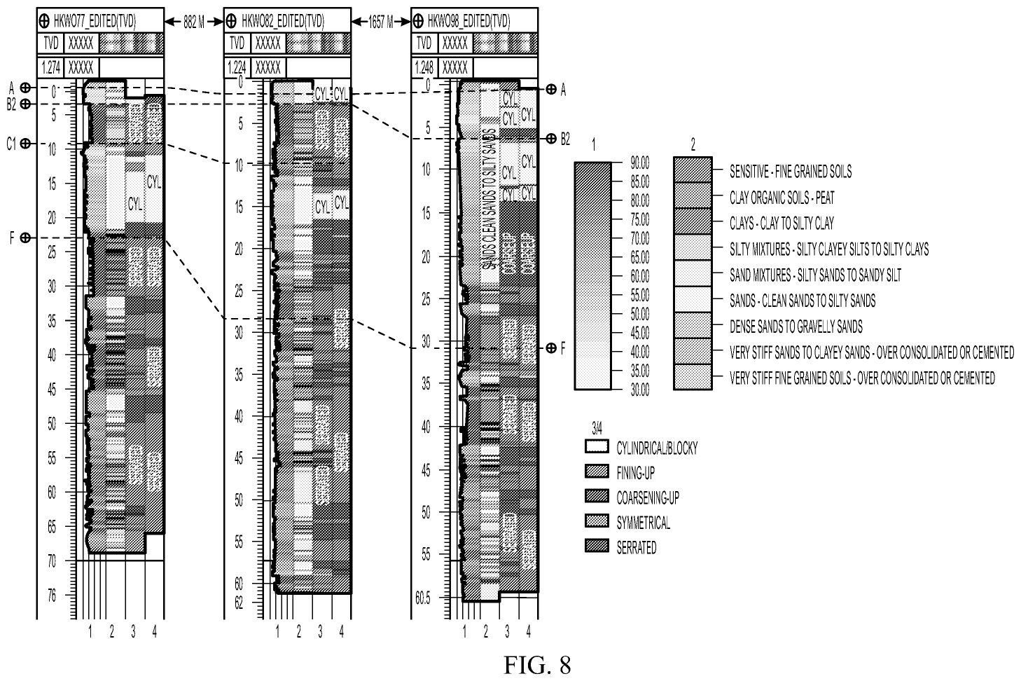

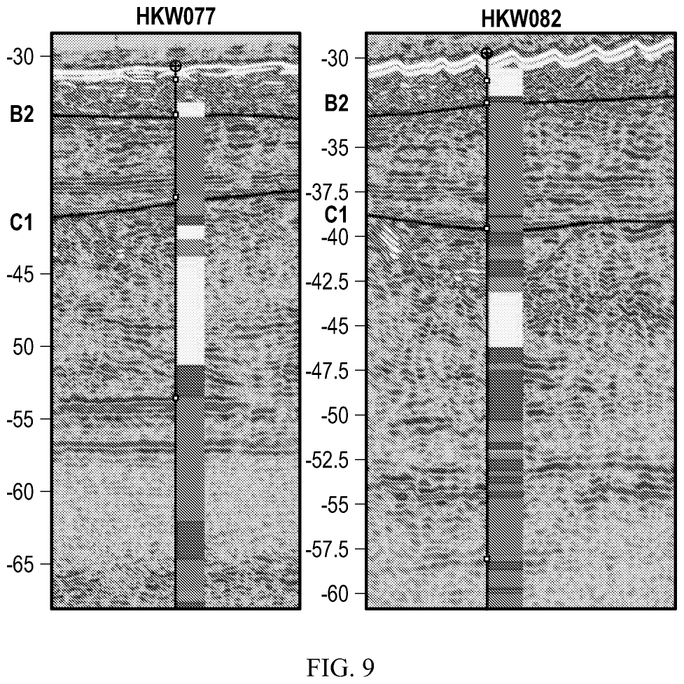

The disclosed method was tested on the data from Hollandse Kust (west) Wind Farm Zone (WFZ). This field is located in the Dutch Sector of the North Sea, approximately 51 km from the coastline of Noord-Holland. The main depositional environments are shallow to open marine and fluvio-deltaic (FIG. 7). The normalized soil behavior index (Ic) from Cone Penetration Test data was used to test the new machine learning (“ML”) model. Note that two different Window Average parameters were used to capture the different scale of grain size trends. The smaller the Window Average is, the smaller trends are captured as illustrated on FIG. 8. Referring to FIG. 8, results of the analysis using CPT data (i.e. Normalized soil behavior index (Ic)) as input. Track 1: Ic log; Track 2: Robertson discrete log; Track 3: Grain size trends (ML results for a window average 2) and Track 4: Grain size trends (ML results for a window average 12). The results provided a very good match between the ML results and the Robertson discrete log, indicating the lithology and grain size. For example, the cylindrical classes (yellow) are associated with ‘Sands: clean sands to silty sands’, which is coherent with channel depositional environments. The serrated classes (brown) are mostly associated with ‘Clays: clay to silty clays’ and ‘Silty mixtures: silty clayey silts to silty clays’, which can be explained by the presence of floodplains. Similarly, the coarsening up classes (blue) are mostly ‘Sands: clean sand to silty sands’ which is compatible with crevasse splays for example. In addition to the good match at each well location, the ML results consistency is confirmed across wells and against other measurements (e.g., seismic data—FIG. 9). This proof of concept validates the application of this method to the civil/geotechnical engineering industry.

In one example embodiment, a method for automated stratigraphy interpretation is disclosed. The method comprises creating at least two training datasets to be used for the interpretation and developing at least one machine learning technique, wherein the at least one learning technique is configured to extract and automatically label stratigraphic trends. The method may further comprise computation of uncertainties for the interpretation.

In another example embodiment, the method may be performed wherein the method is configured to interpret sequence stratigraphy trends from the data sets.

In another example embodiment, the method may be performed wherein the method is configured to interpret grain size trends from the data sets.

In another example embodiment, the method may be performed wherein at least one of the two training datasets is from field well log data.

In another example embodiment, the method may be performed wherein at least one of the two training datasets is from geotechnical data.

In another example embodiment, the method may be performed wherein a machine learning is used to perform the interpretation.

In another example embodiment, the method may be performed wherein the machine learning is performed through a neural network.

In another example embodiment, the method may be performed wherein weights and parameters are calculated with each successive evaluation of a subsequent data set.

In another example embodiment, the method may further comprise improving the created at least two training datasets, wherein training dataset improvement is accomplished by using transfer learning.

In another example embodiment, the method may be performed wherein the improving the created at least two training datasets, wherein training dataset improvement is accomplished by using transfer learning.

In another example embodiment, the method may be performed wherein at least one data set contain data from a gamma ray survey.

In another example embodiment, a computer program product is disclosed. The product may comprise a computer usable medium having a computer readable program code embodied therein, said computer readable program code adapted to be executed to implement a method for generating a report, and configured to run on a computer, said method comprising creating at least two training datasets to be used for the interpretation, developing at least one machine learning technique, wherein the at least one learning technique is configured to extract and automatically label stratigraphic trends and computation of uncertainties for the interpretation.

In another example embodiment, the method may be performed wherein the method further comprises improving the created at least two training datasets, wherein training dataset improvement is accomplished by using transfer learning.

In another example embodiment, the method may be performed wherein the computer is one of a server, a personal computer, a cellular telephone, and a cloud-based computing arrangement.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments, the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 10 degrees, 5 degrees, 3 degrees, 1 degree, or 0.1 degree.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. It is also contemplated that various combinations or sub-combinations of the specific features and aspects of the embodiments described may be made and still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above.

What is claimed is:

1. A method for automated stratigraphy interpretation, comprising:
creating at least two training datasets to be used for the interpretation;
developing at least one machine learning technique, wherein the at least one learning technique is configured to extract and automatically label stratigraphic trends; and
computation of uncertainties for the interpretation.

2. The method according to claim 1, wherein the method is configured to interpret sequence stratigraphy trends from the data sets.

3. The method according to claim 1, wherein the method is configured to interpret grain size trends from the data sets.

4. The method according to claim 1, wherein at least one of the two training datasets is from field well log data.

5. The method according to claim 1, wherein at least one of the two training datasets is from geotechnical data.

6. The method according to claim 1, wherein a machine learning is used to perform the interpretation.

7. The method according to claim 1, wherein the machine learning is performed through a neural network.

8. The method according to claim 7, wherein weights and parameters are calculated with each successive evaluation of a subsequent data set.

9. The method according to claim 1, further comprising:
improving the created at least two training datasets, wherein training dataset improvement is accomplished by using transfer learning.

10. The method according to claim 9, wherein the improving the created at least two training datasets, wherein training dataset improvement is accomplished by using transfer learning.

11. The method according to claim 1, wherein at least one data set contain data from a gamma ray survey.

12. A computer program product, comprising a computer usable medium having a computer readable program code embodied therein, said computer readable program code adapted to be executed to implement a method for generating a report, and configured to run on a computer, said method comprising
creating at least two training datasets to be used for the interpretation;
developing at least one machine learning technique, wherein the at least one learning technique is configured to extract and automatically label stratigraphic trends; and
computation of uncertainties for the interpretation.

13. The computer program product according to claim 10, wherein the method further comprises improving the created at least two training datasets, wherein training dataset improvement is accomplished by using transfer learning.

14. The computer program product according to claim 12, wherein the computer is one of a server, a personal computer, a cellular telephone, and a cloud-based computing arrangement.
